(19) United States
(12) Patent Application Publication
(10) Pub. No.: US 2023/0266483 A1
(43) Pub. Date: Aug. 24, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventor: MASATO KIMISHIMA

(21) Appl. No.: 18/005,190

(22) PCT Filed: May 27, 2021
(86) PCT No.: PCT/JP2021/020166

§ 371 Date: Jan. 12, 2023

(30) Foreign Application Priority Data
Jul. 20, 2020 (JP) 2020-123570

(51) Int. Cl. G01S 19/49; G01S 19/52; G01C 17/30

(52) U.S. Cl. CPC G01S 19/49; G01C 17/30; G01S 19/52

(57) ABSTRACT

Provided is a more widely applicable speed calculation method. An information processing device includes a ground angular velocity calculation unit configured to calculate a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object, and a ground speed calculation unit configured to calculate a ground speed that is a speed of the moving object relative to the ground on the basis of the ground angular velocity and a radius of gyration relating to movement of the moving object.

### TECHNICAL FIELD

The present disclosure relates to an information processing device, an information processing method, and a program.

### BACKGROUND ART

In recent years, information processing devices that receive a global navigation satellite system (GNSS) signal and perform position estimation using the GNSS signal have been widely used. In the open air, it is possible to estimate the position with high accuracy using the GNSS signal, but the accuracy of the position estimation using the GNSS signal deteriorates inside or in an area surrounded by buildings. Therefore, while the GNSS signal is not received with good quality, a certain type of information processing device updates the position by integrating a speed obtained from an inertial measurement unit (IMU).

As a method for obtaining a speed from the IMU, inertial navigation is known. The inertial navigation is a method for calculating a speed by integrating acceleration obtained by an acceleration sensor that is an example of the IMU. It is also possible to calculate a speed using an algorithm tailored to a specific motion model. For example, a speed of a pedestrian can be calculated by pedestrian dead reckoning (PDR). Note that, as disclosed in Patent Document 1, it is also possible to detect the azimuth of a moving object from the IMU.

### CITATION LIST

### Patent Document

Patent Document 1: Japanese Patent Application Laid-Open No. 2019-196976

### SUMMARY OF THE INVENTION

### Problems to Be Solved by the Invention

Even in a case where either inertial navigation or an algorithm tailored to a specific motion model is used, there is however a limitation on a situation in which the estimation accuracy of the speed can be guaranteed. For example, the inertial navigation has constraints such as fast error divergence due to integration and the need for an initial speed. Furthermore, the algorithm tailored to a specific motion model causes a significant decrease in the estimation accuracy in a case where motion largely different from the motion model occurs. In the first place, there is also a motion model for which it is theoretically difficult to construct an algorithm, such as a motion model with less acceleration/deceleration.

Therefore, a more widely applicable speed calculation method has been required.

### SOLUTIONS TO PROBLEMS

According to the present disclosure, provided is an information processing device including a ground angular velocity calculation unit configured to calculate a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object, and a ground speed calculation unit configured to calculate a ground speed that is a speed of the moving object relative to the ground on the basis of the ground angular velocity and a radius of gyration relating to movement of the moving object.

### BRIEF DESCRIPTION OF DRAWINGS

FIG. 1 is an explanatory diagram according to an embodiment of the present disclosure.

FIG. 2 is an explanatory diagram illustrating a configuration of a moving object 20 according to the embodiment of the present disclosure.

FIG. 3 is an explanatory diagram illustrating a specific example of an Earth’s rotation angular velocity serving as a reference value.

FIG. 4 is an explanatory diagram illustrating a specific example of how to remove a bias from an angular velocity.

FIG. 5 is an explanatory diagram illustrating an example of how to calculate a ground angular velocity ωgnd.

FIG. 6 is an explanatory diagram illustrating a relation between a radius of gyration R and an azimuth.

FIG. 7 is an explanatory diagram illustrating a relation between the radius of gyration R and the azimuth.

FIG. 8 is an explanatory diagram illustrating a relation between the radius of gyration R and the azimuth.

FIG. 9 is an explanatory diagram illustrating an example of coordinate transformation of a ground speed Vgnd into a global coordinate system.

FIG. 10 is a flowchart illustrating how the moving object 20 according to the embodiment of the present disclosure operates.

FIG. 11 is an explanatory diagram illustrating a first use case of the embodiment of the present disclosure.

FIG. 12 is an explanatory diagram illustrating a second use case of the embodiment of the present disclosure.

FIG. 13 is an explanatory diagram illustrating a third use case of the embodiment of the present disclosure.

FIG. 14 is an explanatory diagram illustrating a fourth use case of the embodiment of the present disclosure.

FIG. 15 is an explanatory diagram illustrating a fifth use case of the embodiment of the present disclosure.

FIG. 16 is an explanatory diagram illustrating a sixth use case of the embodiment of the present disclosure.

FIG. 17 is an explanatory diagram illustrating a seventh use case of the embodiment of the present disclosure.

FIG. 18 is an explanatory diagram illustrating a hardware configuration of the moving object 20.

### MODE FOR CARRYING OUT THE INVENTION

Hereinafter, a preferred embodiment of the present disclosure will be described in detail with reference to the accompanying drawings. Note that, in the present specification and drawings, components having substantially the same functional configuration are denoted by the same reference numerals to avoid the description from being redundant.

Furthermore, this “MODE FOR CARRYING OUT THE INVENTION” will be described according to the following order of items.
1. Outline
2. Configuration of moving object
3. Operation of moving object
4. Actions and effects
5. Application example
6. Use case
7. Hardware configuration
8. Supplement

### 1. Outline

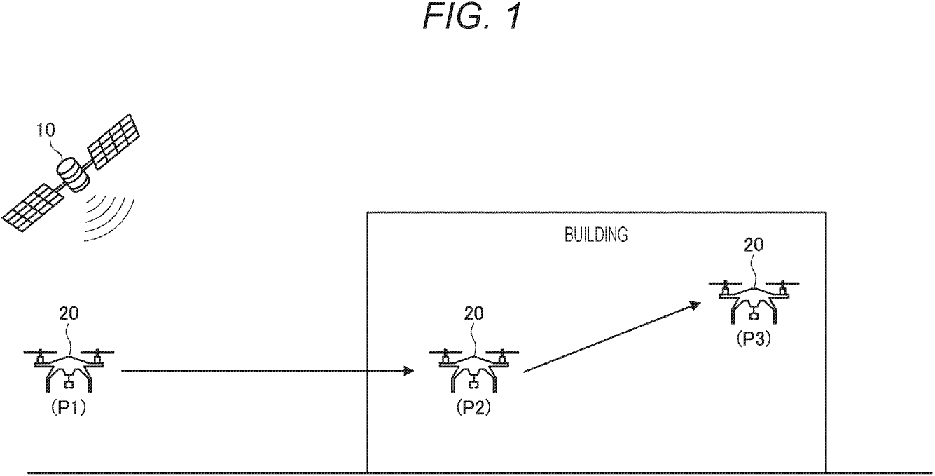

The embodiment of the present disclosure relates to a mechanism for calculating a moving speed of a moving object. Hereinafter, an outline of the embodiment of the present disclosure will be described with reference to FIG. 1.

FIG. 1 is an explanatory diagram according to the embodiment of the present disclosure. As illustrated in FIG. 1, a system according to the embodiment of the present disclosure includes a global positioning system (GPS) satellite 10 and a moving object 20.

The GPS satellite 10 is an artificial satellite that orbits the Earth. The GPS satellite 10 transmits a GNSS signal including a navigation message that contains satellite clock correction data, ephemeris data, and the like.

As illustrated in FIG. 1, the moving object 20 is an unmanned aerial vehicle capable of flying through the air to move, for example. The moving object 20, however, is not limited to such an unmanned aerial vehicle, and other moving objects that generates a driving force for movement, such as a vehicle, a train, and a ship, may be applied to the embodiment of the present disclosure. Furthermore, in the embodiment of the present disclosure, a mobile terminal such as a smartphone or a wearable terminal that is carried by a user and moves as the user moves is also applicable as the moving object 20.

Such a moving object 20 is capable of calculating a position of the moving object 20 on the basis of the GNSS signal transmitted from the GPS satellite 10. Depending on an environment around the moving object 20, it is, however, difficult for the moving object 20 to receive the GNSS signal with good quality. In a case where the quality of reception of the GNSS signal is poor, the calculation of the position of the moving object 20 decreases in accuracy. For example, in a case where the moving object 20 moves in the open air with good visibility like a position P1, the moving object 20 can receive the GNSS signal with good quality. On the other hand, in a case where the moving object 20 moves inside like positions P2 and P3, the quality of reception of the GNSS signal may deteriorate. The quality of reception of the GNSS signal may also deteriorate in an urban area surrounded by buildings or an underground mall.

Therefore, the moving object 20 according to the embodiment of the present disclosure calculates the position of the moving object 20 on the basis of the GNSS signal under an environment where the quality of reception of the GNSS signal is good. On the other hand, under an environment where the quality of reception of the GNSS signal is poor, the moving object 20 according to the embodiment of the present disclosure calculates the position of the moving object 20 by calculating the velocity of the moving object 20 using inertial data obtained from an inertial sensor and integrating the velocity. The method for calculating the velocity by integrating acceleration that is an example of the inertial data, however, makes it difficult to maintain the accuracy of the velocity due to error divergence. The moving object 20 according to the embodiment of the present disclosure is capable of calculating, with high accuracy, a ground speed that is a moving speed of the moving object 20 relative to the ground using the angular velocity of the moving object 20. Hereinafter, the configuration and operation of the moving object 20 according to the embodiment of the present disclosure will be sequentially described in detail.

Note that, herein, an example in which the moving object 20 has a function as an information processing device that calculates the ground speed, the position, and the like of the moving object 20 will be described, but the function as the information processing device may be provided separately from the moving object 20. In this case, the moving object 20 transmits the inertial data measured by the moving object 20 to the information processing device, so as to allow the information processing device to calculate the ground speed, the position, and the like of the moving object 20.

### 2. Configuration of Moving Object

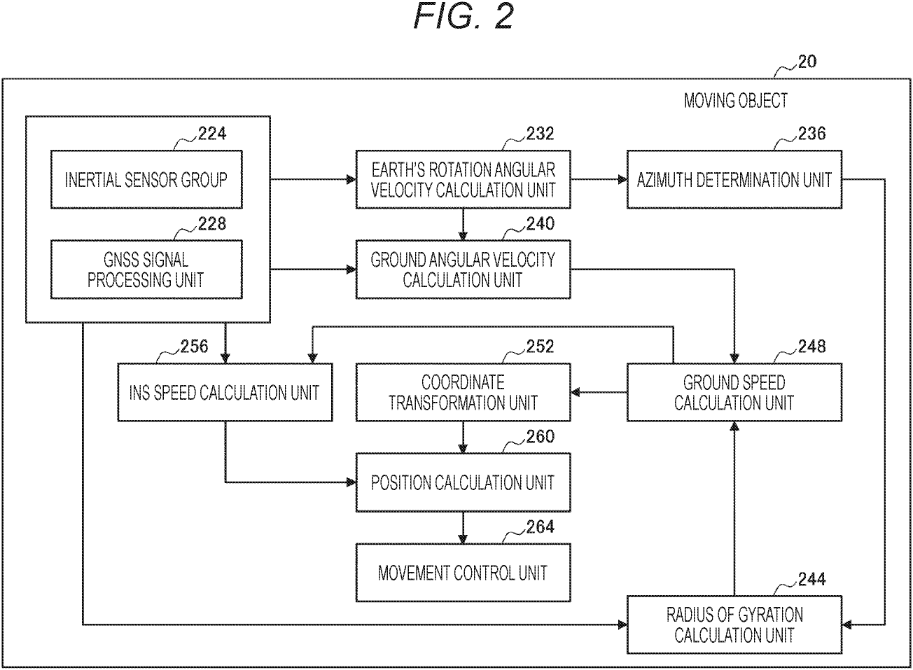

FIG. 2 is an explanatory diagram illustrating the configuration of the moving object 20 according to the embodiment of the present disclosure. As illustrated in FIG. 2, the moving object 20 according to the embodiment of the present disclosure includes an inertial sensor group 224, a GNSS signal processing unit 228, an Earth’s rotation angular velocity calculation unit 232, an azimuth determination unit 236, a ground angular velocity calculation unit 240, a radius of gyration calculation unit 244, a ground speed calculation unit 248, a coordinate transformation unit 252, an INS speed calculation unit 256, a position calculation unit 260, and a movement control unit 264.

### Inertial Sensor Group 224

The inertial sensor group 224 includes a plurality of inertial sensors that measures inertial data. Examples of the inertial sensor include an acceleration sensor that measures the acceleration of the moving object 20, an angular velocity sensor that measures the angular velocity of the moving object 20, and the like.

### GNSS Signal Processing Unit 228

The GNSS signal processing unit 228 receives the GNSS signal from the GPS satellite 10 and processes the GNSS signal to calculate the position and orientation (moving direction) of the moving object 20.

### Earth’s Rotation Angular Velocity Calculation Unit 232

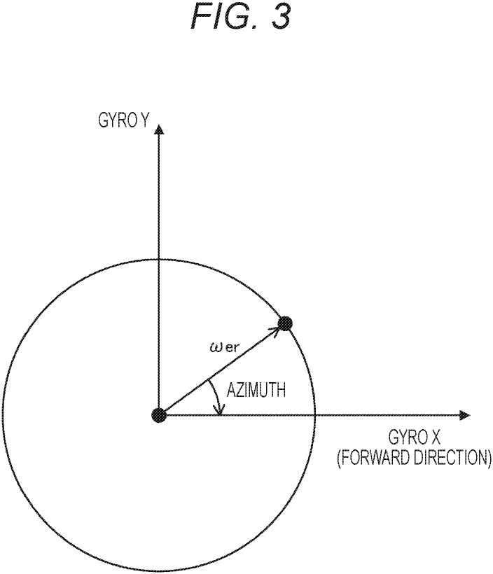

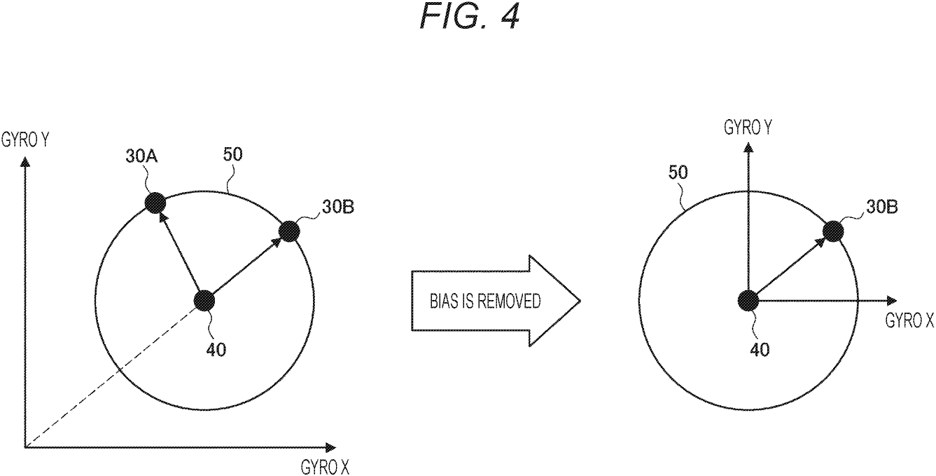

The Earth’s rotation angular velocity calculation unit 232 calculates the Earth’s rotation angular velocity that is an angular velocity produced by the Earth’s rotation. For example, the Earth’s rotation angular velocity calculation unit 232 acquires the Earth’s rotation angular velocity serving as a reference value on the basis of the angular velocity measured when the moving object 20 is at rest, and updates the Earth’s rotation angular velocity in accordance with a change in attitude of the moving object 20. For example, the Earth’s rotation angular velocity calculation unit 232 may detect that the moving object 20 is at rest when the velocity estimated on the basis of the acceleration detected by the inertial sensor group 224 is less than or equal to a threshold. Hereinafter, how to acquire the Earth’s rotation angular velocity serving as the reference value will be described in more details with reference to FIGS. 3 and 4.

FIG. 3 is an explanatory diagram illustrating a specific example of the Earth’s rotation angular velocity serving as the reference value. FIG. 3 illustrates an Earth’s rotation angular velocity ωer on a sensor coordinate system, the Earth’s rotation angular velocity ωer being obtained as a result of measuring the angular velocity when the moving object 20 is at rest. A vector of the Earth’s rotation angular velocity ωer extends toward the north, and magnitude of the Earth’s rotation angular velocity ωer is 12.2 dph (degree per hour) at a latitude where Tokyo is located. In a case where there is no bias in the measured angular velocity, the angular velocity measured when the moving object 20 is at rest as described above can be used as the reference value (initial value) of the Earth’s rotation angular velocity ωer. Note that FIG. 3 illustrates an example in which an X direction (gyro X) in the sensor coordinate system is a forward direction of the moving object 20, that is, the orientation of the moving object 20.

In a case where there is a bias in the measured angular velocity, the Earth’s rotation angular velocity calculation unit 232 may estimate the bias in the measured angular velocity on the basis of angular velocities measured at a plurality of time points at each of which the moving object 20 is different in attitude and the longitude at which the moving object 20 is located, and remove the bias from the measured angular velocity to acquire the reference value of the Earth’s rotation angular velocity ωer. A method for removing the bias will be described with reference to FIG. 4.

FIG. 4 is an explanatory diagram illustrating a specific example of how to remove a bias from an angular velocity. The angular velocity measured by the angular velocity sensor is basically an angular velocity in three axial directions. The measured angular velocity in the three axial directions may contain a bias in a three-dimensional space. A rotation component that is finally calculated exists on the circumference of a circle centered at any position on a plane at a constant elevation angle (latitude). Therefore, if the latitude at which the moving object 20 is located is known, the bias can be estimated not in the three-dimensional space but in the two-dimensional plane.

For example, an angular velocity 30A and an angular velocity 30B measured at a certain latitude are illustrated on the XY plane on the left side of FIG. 4. Note that the angular velocity 30A and the angular velocity 30B are angular velocities measured while the moving object 20 is at rest but is different in attitude. An angular velocity at the center of a circle 50 having a circumference on which the two angular velocities exist is a bias 40. The Earth’s rotation angular velocity calculation unit 232 can calculate the radius of the circle 50 by calculating, on the basis of the Earth’s rotation angular velocity ωer and a latitude θp, ωer × cosθp and obtain the center of the circle 50 on the basis of the radius of the circle 50.

After calculating the bias 40, the Earth’s rotation angular velocity calculation unit 232 can calculate the Earth’s rotation angular velocity ωer by removing the bias 40 from the angular velocity 30. The diagram on the right side of FIG. 4 illustrates, for example, a state in which the bias 40 has been removed from the angular velocity 30B.

Note that the Earth’s rotation angular velocity calculation unit 232 may continue to use the bias estimated once, or may update the bias while the moving object 20 is moving. Even while the moving object 20 is moving, the Earth’s rotation angular velocity calculation unit 232 can estimate and update the bias from angular velocities measured at two time points at each of which the moving object 20 is different in attitude. For example, as described in Japanese Patent Application Laid-Open No. 2019-196976, the Earth’s rotation angular velocity calculation unit 232 may subtract, from each of the angular velocities measured at two time points at each of which the moving object 20 is different in attitude, a motion component corresponding to a change in vector in the gravity direction caused by the movement of the moving object, and apply the estimation method described with reference to FIG. 4 to the angular velocity after the subtraction to estimate and update the bias.

### Azimuth Determination Unit 236

The azimuth determination unit 236 determines an azimuth of the orientation of the moving object 20 relative to the direction of the vector (north direction) of the Earth’s rotation angular velocity ωer on the basis of the reference value of the Earth’s rotation angular velocity ωer acquired by the Earth’s rotation angular velocity calculation unit 232. Moreover, the azimuth determination unit 236 updates the azimuth so as to follow a change in attitude of the moving object 20.

### Ground Angular Velocity Calculation Unit 240

The ground angular velocity calculation unit 240 calculates a ground angular velocity ωgnd that is the angular velocity of the moving object 20 relative to the ground by subtracting the Earth’s rotation angular velocity ωer acquired or calculated by the Earth’s rotation angular velocity calculation unit 232 from the measured angular velocity that is the angular velocity measured by the angular velocity sensor. For example, the ground angular velocity calculation unit 240 may first calculate an observed rotation angular velocity ωobs by removing the angular velocity bias and the motion component of the moving object 20 from the measured angular velocity and then calculate the ground angular velocity ωgnd by subtracting the Earth’s rotation angular velocity ωer from the observed rotation angular velocity ωobs.

Here, the above-described motion component of the moving object 20 is an angular velocity component corresponding to a change in vector in the gravity direction caused by the movement of the moving object 20, that is, an angular velocity component having sensitivity to a change in vector in the gravity direction. For example, as described in Japanese Patent Application Laid-Open No. 2019-196976, the ground angular velocity calculation unit 240 can calculate the motion component on the basis of the inertial data obtained from the inertial sensor group 224.

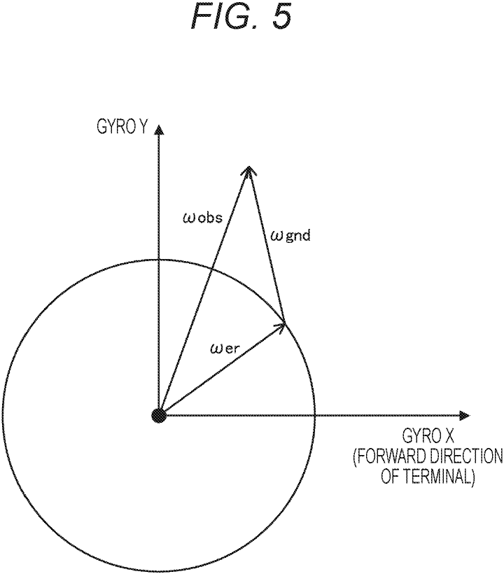

FIG. 5 is an explanatory diagram illustrating an example of how to calculate the ground angular velocity ωgnd. As illustrated in FIG. 5, the ground angular velocity calculation unit 240 calculates the ground angular velocity ωgnd by the operation of ωgnd(t) = ωobs(t) - ωer(t). Here, the observed rotation angular velocity ωobs contains only a plane component because the motion component in the gravity direction has been removed. Therefore, the ground angular velocity ωgnd is also calculated as an angular velocity on the XY plane.

### Radius of Gyration Calculation Unit 244

The radius of gyration calculation unit 244 calculates a radius of gyration R relating to the movement of the moving object 20 on the basis of the azimuth determined by the azimuth determination unit 236, the latitude (lat) at which the moving object 20 is located, and an Earth’s radius Rearth.

The Earth’s radius Rearth varies in a manner that depends on a location, and has a value within a range of 6356 to 6377 km. The radius of gyration calculation unit 244 may uniquely determine the Earth’s radius Rearth by consulting a database in which latitude and longitude are associated with the radius of gyration R. Note that, as will be described later in detail, the latitude and longitude of the moving object 20 that are obtained for determining the Earth’s radius Rearth are low in accuracy. Therefore, even if the moving object 20 is in a place where the quality of reception of the GNSS signal is poor such as an area surrounded by buildings, the latitude and longitude obtained from the GNSS signal processing unit 228 can be used for determining the Earth’s radius Rearth. Alternatively, the latitude and longitude obtained on the basis of reception of WiFi radio waves or communications with a cellular base station may be used for determining the Earth’s radius Rearth. Moreover, in a case where a maximum allowable error of the Earth’s radius Rearth is about 10 km, the radius of gyration calculation unit 244 may determine the Earth’s radius Rearth to be a fixed value (for example, 6366 km).

The radius of gyration calculation unit 244 calculates, as the radius of gyration R, the radius of a circle drawn by the movement of the moving object 20 from the position of the moving object 20 in the azimuth. Specifically, the radius of gyration calculation unit 244 calculates the radius of gyration R in accordance with the following equation:

$$\begin{matrix}\text{Radius of gyration R = Rearth} \left(\text{lat, lon}\right) \times \left(\text{1} - \left|\text{sin} \left(\text{lat}\right)\right| \times \right) \\ \left(\left(1 - cos \left(2 * \text{azimuth}\right)\right) / 2\right)\end{matrix}$$

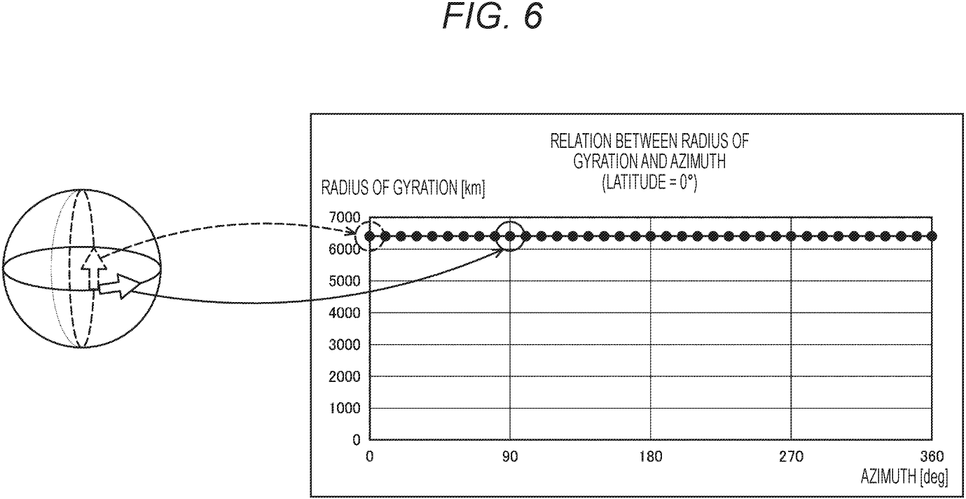

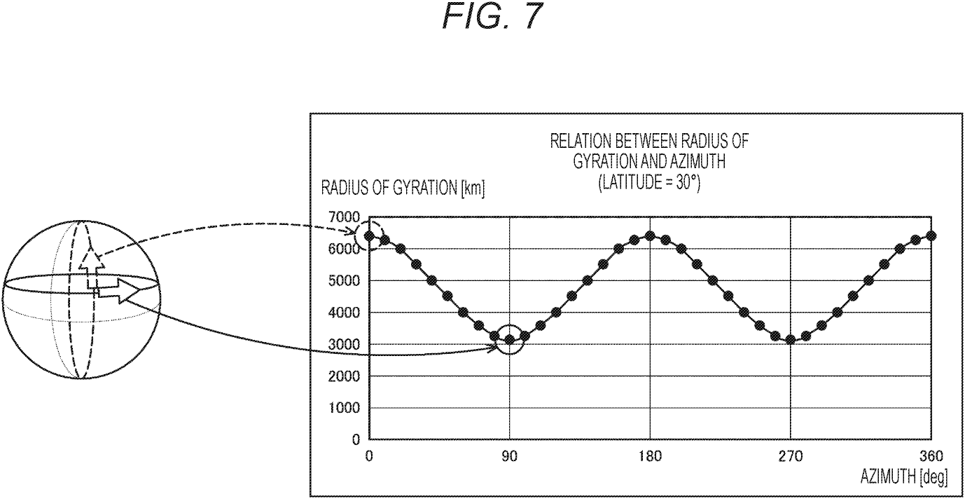

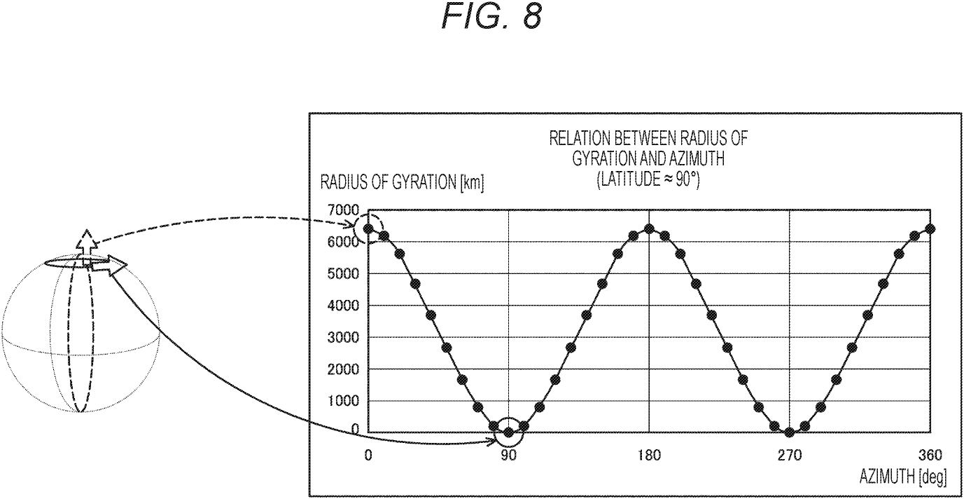

FIGS. 6 to 8 are explanatory diagrams illustrating the radius of gyration R calculated by the above-described equation. Specifically, FIG. 6 illustrates the radius of gyration R for each azimuth calculated in a case where the position of the moving object 20 is located on the equator (lat = 0), FIG. 7 illustrates the radius of gyration R for each azimuth calculated in a case where the latitude is 30 degrees, and FIG. 8 illustrates the radius of gyration R for each azimuth calculated in a case where the moving object 20 is located near a pole (lat ≈ ±90 degrees).

As illustrated in FIG. 6, in a case where the moving object 20 is located on the equator, the Earth’s radius Rearth is calculated as the radius of gyration R regardless of the azimuth of the moving object 20. Note that, in FIGS. 6 to 8, a solid circle given to a sphere corresponding to the Earth indicates a movement route in a case where the azimuth is ±90 degrees (that is, an east-west direction), and a dashed circle indicates a movement route in a case where the azimuth is 0 degrees or 180 degrees (that is, a north-south direction).

As illustrated in FIG. 7, in a case where the latitude is 30 degrees, the radius of gyration R becomes the largest in a case where the azimuth is 0 degrees or 180 degrees (that is, the north-south direction), and the radius of gyration R becomes the smallest in a case where the azimuth is ±90 degrees (that is, the east-west direction).

As illustrated in FIG. 8, also in a case where the moving object 20 is located near a pole (lat ≈ ±90 degrees), the radius of gyration R becomes the largest in a case where the azimuth is 0 degrees or 180 degrees (that is, the north-south direction), and the radius of gyration R becomes the smallest in a case where the azimuth is ±90 degrees (that is, the east-west direction). In particular, in a case where the azimuth is ±90 degrees (that is, the east-west direction), the radius of gyration R becomes approximately equal to 0.

### Ground Speed Calculation Unit 248

The ground speed calculation unit 248 calculates a ground speed Vgnd that is the speed of the moving object 20 relative to the ground on the basis of the ground angular velocity ωgnd calculated by the ground angular velocity calculation unit 240 and the radius of gyration R calculated by the radius of gyration calculation unit 244. Specifically, the ground speed calculation unit 248 may calculate the ground speed Vgnd by the following equation:

$$\text{Ground speed Vgnd = R} \times ω \text{gnd}$$

### Coordinate Transformation Unit 252

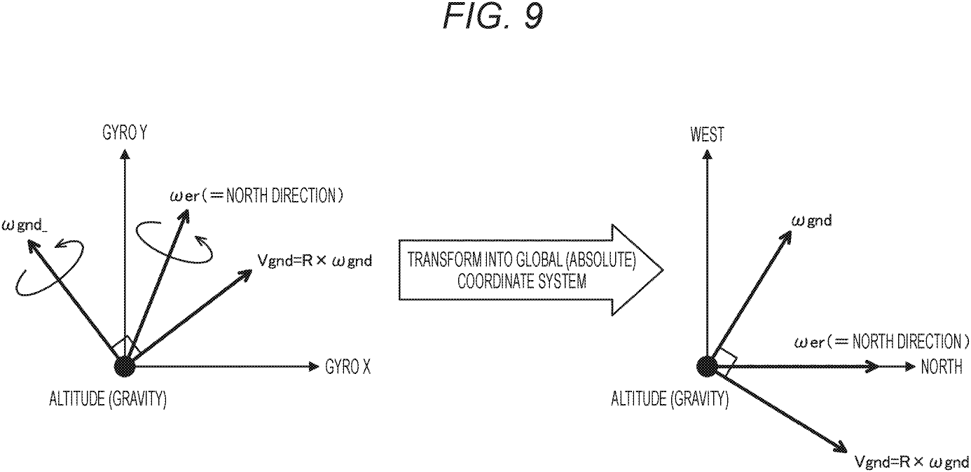

The coordinate transformation unit 252 coordinate-transforms the ground speed Vgnd calculated by the ground speed calculation unit 248 from a value in the sensor coordinate system into a value in the global coordinate system. The coordinate transformation will be described in detail with reference to FIG. 9.

FIG. 9 is an explanatory diagram illustrating an example of coordinate transformation of the ground speed Vgnd into the global coordinate system. As illustrated in the left diagram in FIG. 9, in the sensor coordinate system, a direction in which the ground angular velocity ωgnd is rotated clockwise by 90 degrees is a direction of the ground speed Vgnd. As illustrated in the right diagram in FIG. 9, the coordinate transformation unit 252 can obtain the ground speed Vgnd in the global coordinate system by rotating the ground speed Vgnd so as to make the direction of the vector of the Earth’s rotation angular velocity ωer coincident with the orientation of the moving object 20 (in the example illustrated in FIG. 9, the X direction) in the sensor coordinate system.

### INS Speed Calculation Unit 256

The INS speed calculation unit 256 calculates the moving speed of the moving object 20 by integrating the acceleration of the moving object 20 measured by the inertial sensor group 224. For example, the INS speed calculation unit 256 serves as a vertical speed calculation unit that calculates a vertical speed of the moving object 20 by integrating the acceleration of the moving object 20 in an estimated altitude direction that is an altitude direction based on estimation.

### Position Calculation Unit 260

The position calculation unit 260 calculates a three-dimensional position of the moving object 20 on the basis of the ground speed Vgnd in the global coordinate system obtained by the coordinate transformation unit 252 and the vertical speed calculated by the INS speed calculation unit 256. Specifically, the position calculation unit 260 may calculate a position of the moving object 20 on the horizontal plane by integrating the ground speed Vgnd, and calculate a position of the moving object 20 in the altitude direction by integrating the vertical speed. Note that the position calculation unit 260 can also calculate the position of the moving object 20 in the altitude direction on the basis of an air pressure measured by a barometer instead of the vertical speed calculated by the INS speed calculation unit 256.

### Movement Control Unit 264

The movement control unit 264 controls the movement of the moving object 20 on the basis of the position of the moving object 20 calculated by the position calculation unit 260. For example, the movement control unit 264 controls the generation of the driving force for moving the moving object 20 so as to allow the moving object 20 to reach a target position on the basis of the position of the moving object 20 and the target position of the moving object 20. Note that the movement control unit 264 is an example of a function using the position of the moving object 20 calculated by the position calculation unit 260, and another function using the position of the moving object 20 calculated by the position calculation unit 260 may be implemented. For example, in a case where the information processing device is provided separately from the moving object 20, the information processing device may include a display control unit that causes a display unit to display the position and the ground speed Vgnd of the moving object 20, and the like.

### 3. Operation of Moving Object

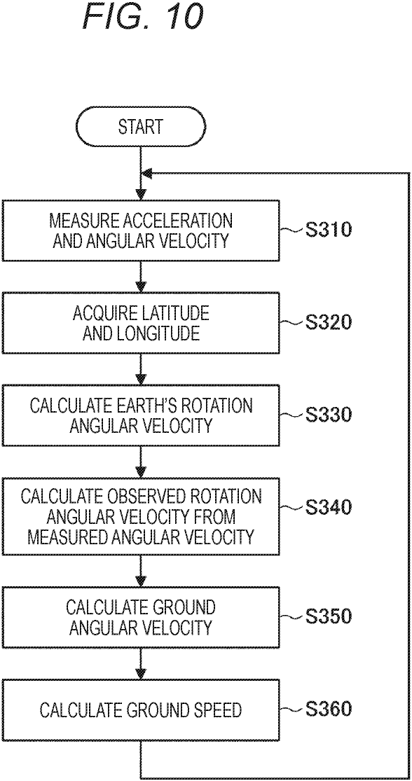

The configuration of the moving object 20 according to the embodiment of the present disclosure has been described above. Next, the operation of the moving object 20 according to the embodiment of the present disclosure will be summarized with reference to FIG. 10.

FIG. 10 is a flowchart illustrating how the moving object 20 according to the embodiment of the present disclosure operates. As illustrated in FIG. 10, first, the inertial sensor group 224 of the moving object 20 measures the acceleration and the angular velocity of the moving object 20 (S310). The processing from S310 to S360 including S310 may be repeated for each measurement of one sample of the acceleration and the angular velocity, or may be repeated for each measurement of a plurality of samples of the acceleration and the angular velocity.

Subsequently, the GNSS signal processing unit 228 processes the GNSS signal to acquire the latitude and longitude of the moving object 20 (S320). As another method, it is also possible to acquire the latitude and longitude on the basis of reception of WiFi radio waves or communications with a cellular base station.

Then, the Earth’s rotation angular velocity calculation unit 232 calculates the Earth’s rotation angular velocity ωer (S330). In a case where the moving object 20 is at rest, the Earth’s rotation angular velocity calculation unit 232 acquires the angular velocity measured by the inertial sensor group 224 as the reference value of the Earth’s rotation angular velocity ωer, and in a case where the moving object 20 changes in attitude, the Earth’s rotation angular velocity ωer is updated in accordance with the change in attitude of the moving object 20.

Subsequently, the ground angular velocity calculation unit 240 calculates the observed rotation angular velocity ωobs from the measured angular velocity measured by the inertial sensor group 224 (S340). Specifically, the ground angular velocity calculation unit 240 calculates the observed rotation angular velocity ωobs by removing the angular velocity bias and the motion component of the moving object 20 from the measured angular velocity.

Subsequently, the ground angular velocity calculation unit 240 calculates the ground angular velocity ωgnd by subtracting the Earth’s rotation angular velocity ωer from the observed rotation angular velocity ωobs (S350).

Moreover, the radius of gyration calculation unit 244 calculates the radius of gyration R relating to the movement of the moving object 20, and the ground speed calculation unit 248 calculates the ground speed Vgnd that is the speed of the moving object 20 relative to the ground on the basis of the radius of gyration R calculated by 244 and the ground angular velocity ωgnd calculated by the ground angular velocity calculation unit 240 (S360). Then, the processing is repeated from S310.

### 4. Actions and Effects

According to the embodiment of the present disclosure described above, various actions and effects can be obtained. For example, in the embodiment of the present disclosure, it is possible to calculate the ground speed Vgnd by multiplying the ground angular velocity ωgnd calculated by the Earth’s rotation angular velocity calculation unit 232 of the moving object 20 by the radius of gyration R relating to the movement of the moving object 20. Therefore, in the embodiment of the present disclosure, it is possible to calculate the ground speed Vgnd without being restricted by a situation where the speed can be calculated with high accuracy by another method for calculating the speed of the moving object 20 such as inertial navigation or a method using an algorithm tailored to a specific motion model. That is, according to the embodiment of the present disclosure, it is possible to provide a more widely applicable method for calculating the ground speed Vgnd.

Furthermore, in the embodiment of the present disclosure, the Earth’s rotation angular velocity calculation unit 232 acquires the Earth’s rotation angular velocity ωer serving as the reference value on the basis of the measurement of the angular velocity when the moving object 20 is at rest. Moreover, the Earth’s rotation angular velocity calculation unit 232 can also estimate a bias in the measured angular velocity on the basis of the angular velocities measured at a plurality of time points at each of which the moving object 20 is different in attitude and the longitude at which the moving object 20 is located, and remove the bias from the measured angular velocity to acquire the reference value of the Earth’s rotation angular velocity ωer. Therefore, the Earth’s rotation angular velocity calculation unit 232 can acquire the reference value of the Earth’s rotation angular velocity ωer with higher accuracy.

Furthermore, in the embodiment of the present disclosure, the ground angular velocity calculation unit 240 calculates the ground angular velocity ωgnd by subtracting, from the measured angular velocity that is an angular velocity measured by the inertial sensor group 224, the angular velocity bias and the motion component corresponding a change in vector in the gravity direction caused by the movement of the moving object 20 in addition to the Earth’s rotation angular velocity ωer. It is therefore possible to make the calculation of the ground angular velocity ωgnd higher in accuracy.

Furthermore, in the embodiment of the present disclosure, in order to calculate the radius of gyration R relating to the movement of the moving object 20, the radius of gyration calculation unit 244 determines the Earth’s radius Rearth in accordance with the latitude and longitude at which the moving object 20 is located. According to such a configuration, it is possible to make the calculation of the radius of gyration R relating to the movement of the moving object 20 higher in accuracy.

Furthermore, in the embodiment of the present disclosure, the coordinate transformation unit 252 coordinate-transforms the ground speed Vgnd from a value in the sensor coordinate system to a value in the global coordinate system. The ground speed Vgnd of the moving object 20 is expressed in the global coordinate system, so that the ground speed Vgnd can be used for various purposes.

Furthermore, in the embodiment of the present disclosure, the INS speed calculation unit 256 calculates the vertical speed of the moving object 20. It is therefore possible to pick up, by combining the ground speed Vgnd calculated by the ground speed calculation unit 248 and the vertical speed calculated by the INS speed calculation unit 256, three-dimensional movement of the moving object 20.

Further details about the fact that the latitude and longitude of the moving object 20 that are obtained for determining the Earth’s radius Rearth are low in accuracy will be given below. According to the heat map indicating the Earth’s radius Rearth at each point, even in a place where a variation in altitude is large, the variation in altitude is merely up to about 10 km as compared with a variation in the horizontal direction of 100 km to 1000 km. An error in the ground speed Vgnd in a case where the error of 10 km is included in the Earth’s radius Rearth is 0.2% (10 km/6356 km). It is therefore considered that even if an environment under which the GNSS signal or the like is received is poor, the accuracy of the latitude and longitude of the moving object 20 obtained for determining the Earth’s radius Rearth is high enough.

Note that, in a case where the moving object moves at the ground speed Vgnd of 1 m/s, when the radius of gyration R is 6,356,000 m, the ground angular velocity ωgnd becomes 0.03 dph by the operation of 1/6,356,000. In a case where a resolution of ⅒ is desired for sensing the ground angular velocity ωgnd of 0.03 dph, performance (resolution) required for the angular velocity sensor is 0.003 dph. On the other hand, in a case where the moving object moves at the ground speed Vgnd of 1 m/s, the performance required for the angular velocity sensor is 0.03 dph. As described above, in the embodiment of the present disclosure, the higher the moving speed of the moving object 20, the lower the performance required for the angular velocity sensor, so that it is possible to implement the embodiment of the present disclosure more easily.

### 5. Application Example

The embodiment of the present disclosure have been described above. Hereinafter, an application example of the embodiment of the present disclosure will be described.

The moving object 20 according to the application example may use the INS-based speed of the moving object 20 calculated by the INS speed calculation unit 256 and the ground speed Vgnd together as the horizontal speed (ground speed) of the moving object 20. Note that the error divergence of the INS is fast, so that it is desirable that the error divergence of the INS be corrected.

As a technique for correcting the error divergence of the INS, there is a possible technique by which the error divergence of the INS is corrected by using a result of observation of a carrier wave speed of the GNSS signal. Specifically, the result of observation of the carrier wave speed of the GNSS signal indicates a speed corresponding to the moving speed of the moving object due to the Doppler effect, so that it is possible to calculate the moving speed of the moving object from the result of observation of the carrier wave speed. Setting this moving speed as a constraint condition allows the error divergence of the INS to be corrected.

The INS speed calculation unit 256 of the moving object 20 according to the application example may correct the error divergence of the INS by replacing the result of observation of the carrier wave speed of the GNSS signal according to the above-described technique with the ground speed Vgnd described in the embodiment of the present disclosure. For example, the INS speed calculation unit 256 may correct, using the ground speed Vgnd as the constraint condition, the estimated altitude direction (gravity direction), which is a premise of calculation of the horizontal speed, on the basis of a difference between the horizontal speeds calculated from the ground speed Vgnd and the INS. As a result, it is possible to more accurately separate an acceleration component in the horizontal direction and an acceleration component in the altitude direction, so that it is possible to make the calculation of the horizontal speed by the INS higher in accuracy and further make the calculation of the vertical speed higher in accuracy. The ground speed Vgnd can also be used as an initial speed for the INS speed calculation unit 256 to calculate the horizontal speed from the INS.

Here, it is assumed that intervals at which the ground speed Vgnd is obtained are longer than intervals at which the calculation result of the horizontal speed is obtained from the INS. Therefore, the moving object 20 may use the speed calculated from the INS in an interpolation manner while the ground speed Vgnd cannot be obtained. Furthermore, in order to increase the resolution (S/N) of the angular velocity, a gyroscope having a high S/N such as a multi-gyroscope composition may be used, and in this case, it is possible to make the error divergence of the INS slower and make the correction convergence using the ground speed Vgnd faster, for example.

### 6. Use Case

The embodiment and application example of the present disclosure have been described above. Some use cases of the embodiment of the present disclosure will be given below as examples.

### First Use Case

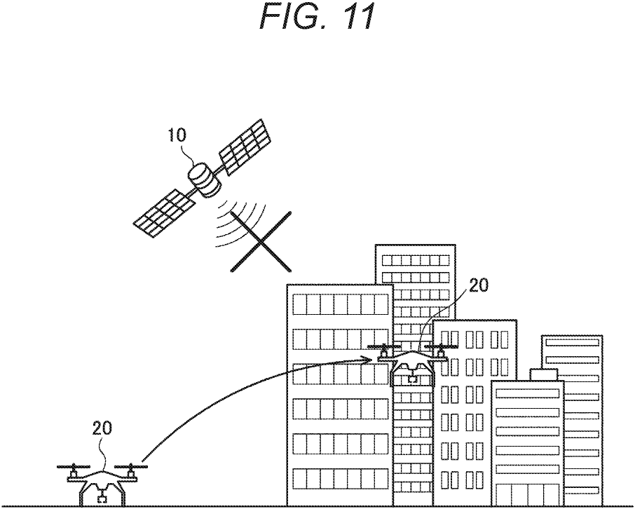

FIG. 11 is an explanatory diagram illustrating a first use case of the embodiment of the present disclosure. As illustrated in FIG. 11, the Earth’s rotation angular velocity calculation unit 232 calculates the Earth’s rotation angular velocity ωer while the moving object 20 is at rest before the moving object 20 takes off. Thereafter, as illustrated in FIG. 11, when the moving object 20 moves to an area surrounded by buildings where the quality of reception of the GNSS signal is poor, the ground speed calculation unit 248 calculates the ground speed Vgnd using the technology of the present disclosure. It is difficult for the unmanned aerial vehicle illustrated as an example of the moving object 20 to estimate the speed from a motion model, but according to the embodiment of the present disclosure, the ground speed Vgnd can be directly calculated from the angular velocity of the moving object 20. Furthermore, the calculation of the ground speed Vgnd by the ground speed calculation unit 248 also has an advantage that the error divergence is slower than the calculation based on the INS.

### Second Use Case

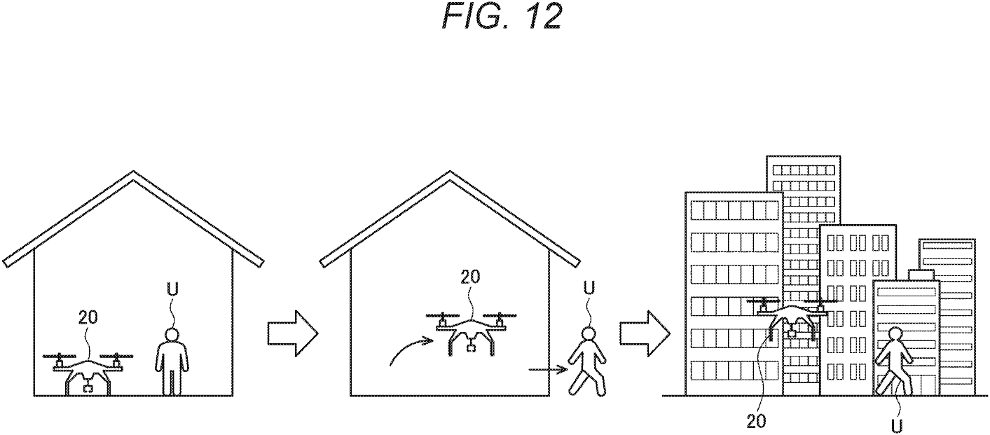

FIG. 12 is an explanatory diagram illustrating a second use case of the embodiment of the present disclosure. In a state illustrated in the left diagram in FIG. 12, a user U and the moving object 20 are located in the home of the user U, and the user U and the moving object 20 are at rest. The Earth’s rotation angular velocity calculation unit 232 of the moving object 20 calculates the Earth’s rotation angular velocity ωer while the moving object 20 is at rest. Thereafter, as illustrated in the middle diagram in FIG. 12, when the user U starts to move, the moving object 20 moves to follow the user U.

The moving object 20 can detect the movement of the user U by various methods. For example, the user U carries an information terminal, and the moving object 20 may detect the movement of the user U on the basis of communications with the information terminal. More specifically, the information terminal may calculate the position of the information terminal on the basis of processing on the GNSS signal, PDR by the IMU, or the like, and transmit information indicating the position to the moving object 20. In this case, the moving object 20 can detect the movement of the user U in accordance with a change in position indicated by the information received from the information terminal. Alternatively, the movement of the user U may be detected on the basis of disconnection of WiFi connection or Bluetooth (registered trademark) connection between the information terminal and the moving object 20.

Then, as illustrated in the right diagram in FIG. 12, while the user U is moving in an area surrounded by buildings or the like, the moving object 20 calculates the ground speed Vgnd and estimates the position of the moving object 20 on the basis of the ground speed Vgnd. Note that the IMU (inertial sensor group 224) mounted on the moving object 20 is desirably higher in accuracy than the IMU of the information terminal carried by the user U for the calculation of the ground speed Vgnd.

### Third Use Case

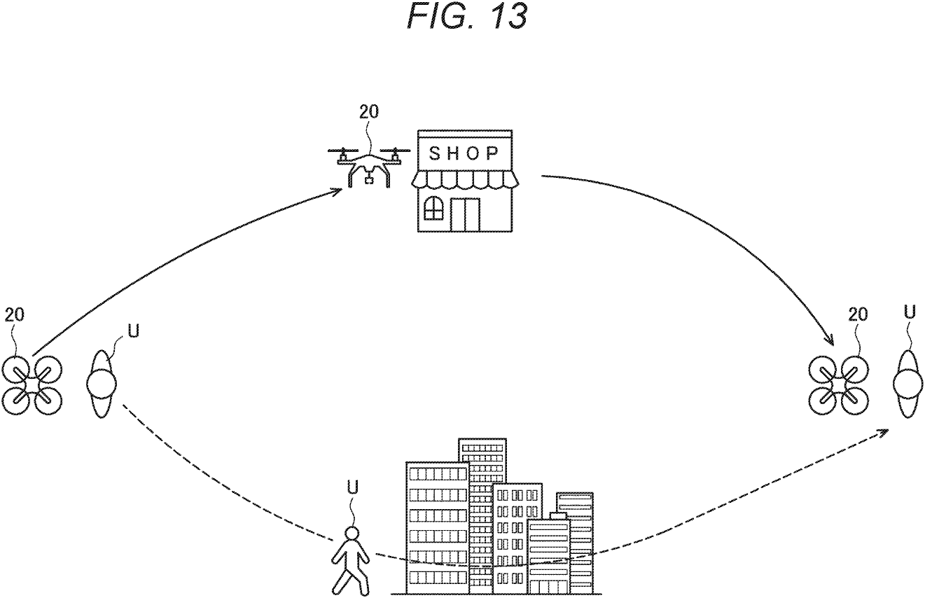

FIG. 13 is an explanatory diagram illustrating a third use case of the embodiment of the present disclosure. In the third use case, the moving object 20 joins the user U after moving along a route that is different from a route of the user U. First, while the moving object 20 is following the user U, the ground speed Vgnd and the position of the moving object 20 calculated by the moving object 20 with high accuracy can be used as the moving speed and the position of the user U.

Thereafter, as illustrated in FIG. 13, for example, in a case where the moving object 20 goes to a shop and the user U waits or moves along another route, the information terminal uses the position calculated by the PDR as the position of the user U. Even while the moving object 20 and the user U are away from each other, the moving object 20 and the information terminal carried by the user U share their respective positions via mutual communication.

Then, in order for the moving object 20 and the user U to join each other, the moving object 20 moves toward the position of the user U transmitted from the information terminal. After the moving object 20 joins the user U, the information terminal uses again the ground speed Vgnd and the position of the moving object 20 calculated by the moving object 20 with high accuracy as the moving speed and the position of the user U.

### Fourth Use Case

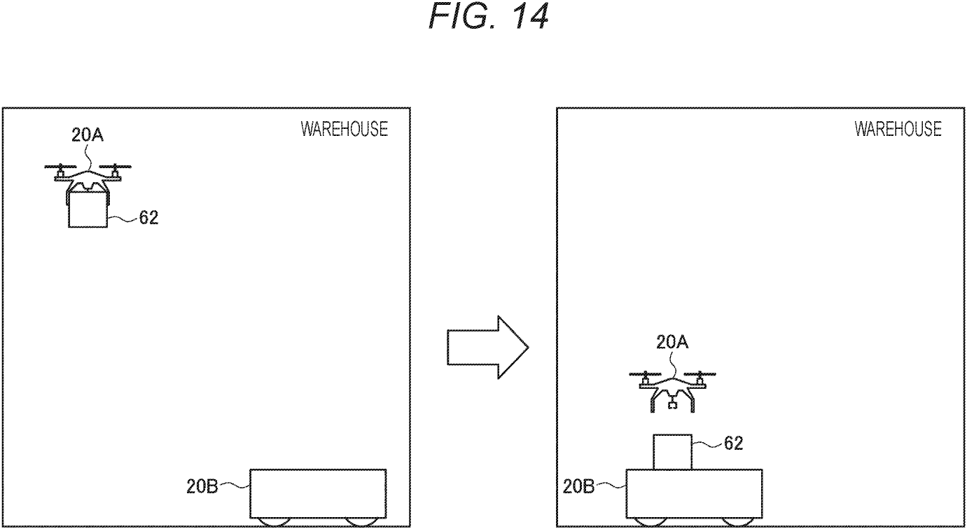

FIG. 14 is an explanatory diagram illustrating a fourth use case of the embodiment of the present disclosure. In the fourth use case, the moving object 20 is used to carry a load in a warehouse. As illustrated in the left diagram in FIG. 14, a moving object 20A that flies and a moving object 20B that is self-propelled on a floor surface are located in the warehouse. The moving object 20A is used to pick up and carry a load placed at a high position, and the moving object 20B is used to carry many loads to a pickup point. The moving object 20A and the moving object 20B calculate their respective ground speeds Vgnd and positions using the technology of the present disclosure, and share their respective positions via mutual communication. Note that a server that manages the position of each moving object 20 in a centralized manner may be provided.

When the moving object 20A reaches a target load position and picks up a load 62, as illustrated in the right diagram in FIG. 14, the moving object 20B moves toward the moving object 20A, the moving object 20A also moves toward the moving object 20B, and the moving object 20B receives the load 62 from the moving object 20A. Note that, after the moving object 20A and the moving object 20B move close to each other to some extent, the moving object 20A and the moving object 20B may finely adjust a position where the load 62 is handed over using an imaging device, a proximity sensor, or the like mounted on the moving object 20A and the moving object 20B.

### Fifth Use Case

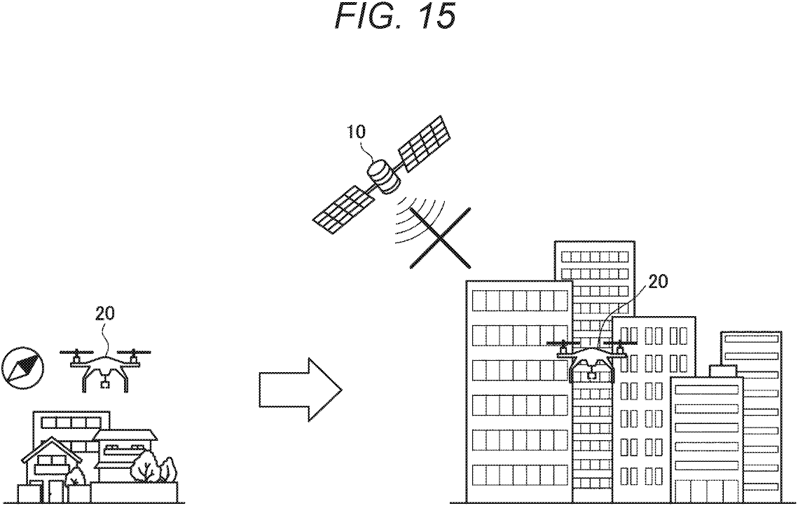

FIG. 15 is an explanatory diagram illustrating a fifth use case of the embodiment of the present disclosure. There may be a case where the rest time before the moving object 20 takes off is not enough for successful calculation of the Earth’s rotation angular velocity ωer. In such a case, as illustrated in the left diagram in FIG. 15, the moving object 20 may acquire a geomagnetic azimuth from a geomagnetic sensor while the moving object 20 is moving in a place under a good magnetic environment.

Here, as illustrated in FIG. 3, if the latitude is known, the azimuth of the moving object 20 and the Earth’s rotation angular velocity ωer can be mutually converted. Therefore, the Earth’s rotation angular velocity calculation unit 232 of the moving object 20 may calculate the Earth’s rotation angular velocity ωer on the basis of the geomagnetic azimuth and the latitude. Thereafter, as illustrated in the left diagram in FIG. 15, while the moving object 20 is moving in an area surrounded by buildings or the like, the Earth’s rotation angular velocity calculation unit 232 updates the Earth’s rotation angular velocity ωer calculated on the basis of the geomagnetic azimuth and the latitude in accordance with a change in attitude of the moving object 20, thereby allowing the ground speed calculation unit 248 to calculate the ground speed Vgnd using the updated Earth’s rotation angular velocity ωer. As described above, the use of the geomagnetic sensor eliminates the need of the rest time for successful calculation of the Earth’s rotation angular velocity ωer, which increases convenience.

### Sixth Use Case

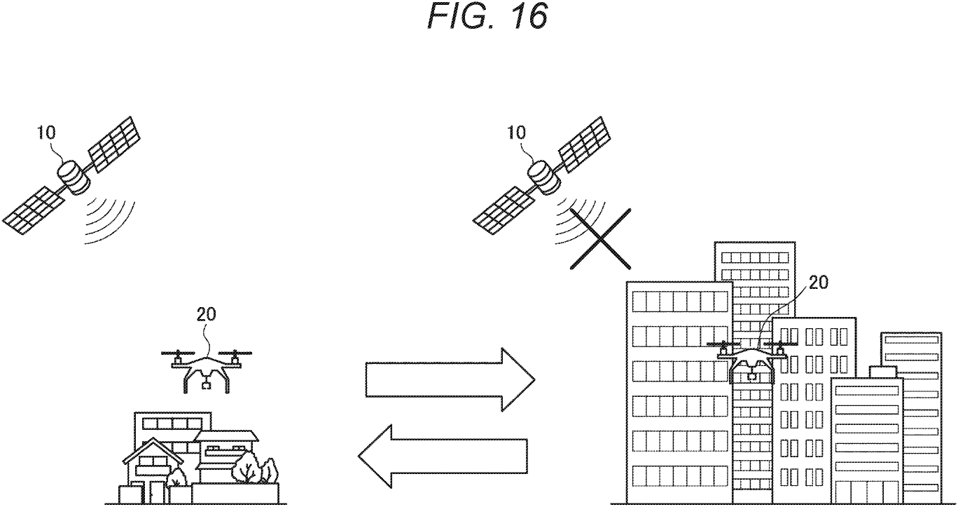

FIG. 16 is an explanatory diagram illustrating a sixth use case of the embodiment of the present disclosure. The GNSS signal is processed for estimation of a direction of acceleration/deceleration of the moving object 20 in the global coordinate system. Furthermore, the inertial sensor group 224 measures the direction of acceleration/deceleration of the moving object 20 in the sensor coordinate system. The Earth’s rotation angular velocity calculation unit 232 may calculate the north direction in the sensor coordinate system, the absolute bearing of the moving object 20, and the Earth’s rotation angular velocity ωer on the basis of a relation between the direction of acceleration/deceleration of the moving object 20 in the global coordinate system and the direction of acceleration/deceleration of the moving object 20 in the sensor coordinate system.

For example, as illustrated in the left diagram in FIG. 16, under an environment where the GNSS signal can be received with good quality, the Earth’s rotation angular velocity calculation unit 232 calculates the Earth’s rotation angular velocity ωer as described above, and the ground speed calculation unit 248 calculates the ground speed Vgnd using the Earth’s rotation angular velocity ωer. Then, as illustrated in the right diagram in FIG. 16, when the moving object 20 moves to an area surrounded by buildings or the like, the Earth’s rotation angular velocity calculation unit 232 updates the Earth’s rotation angular velocity ωer in accordance with a change in attitude of the moving object 20, and the ground speed calculation unit 248 calculates the ground speed Vgnd using the updated Earth’s rotation angular velocity ωer. Moreover, when the moving object 20 returns to the environment where the GNSS signal can be received with good quality as illustrated in the left diagram in FIG. 16, the ground speed calculation unit 248 may correct the ground speed Vgnd with the moving speed of the moving object 20 obtained by processing the GNSS signal.

### Seventh Use Case

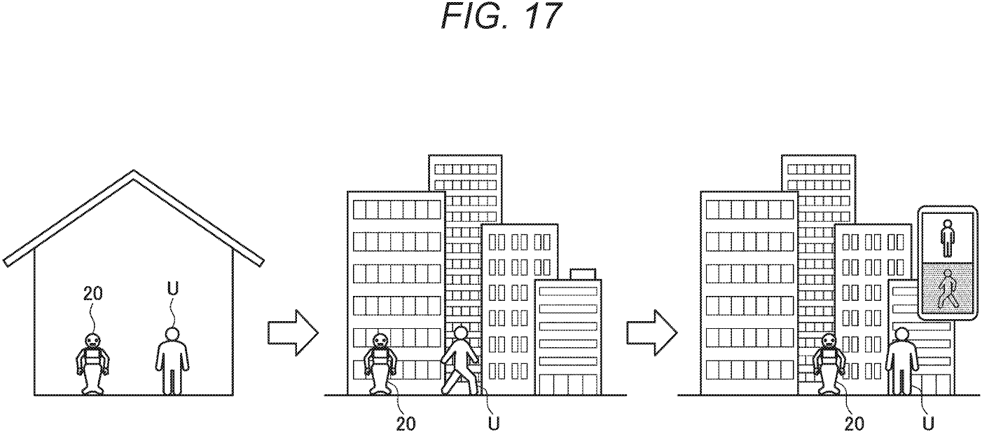

FIG. 17 is an explanatory diagram illustrating a seventh use case of the embodiment of the present disclosure. FIG. 17 illustrates a robot that moves on the ground as the moving object 20. In a state illustrated in the left diagram in FIG. 17, the user U and the moving object 20 are located in the home of the user U, and the user U and the moving object 20 are at rest. The Earth’s rotation angular velocity calculation unit 232 of the moving object 20 calculates the Earth’s rotation angular velocity ωer while the moving object 20 is at rest.

Then, as illustrated in the middle diagram in FIG. 17, when the user U starts to move, the moving object 20 moves to follow the user U. While the moving object 20 is moving, the moving object 20 calculates the ground speed Vgnd of the moving object 20. In a case where the moving object 20 is a robot that moves on the ground, unlike a case where the moving object 20 is an unmanned aerial vehicle, the moving object 20 is installed all the time, and often stops as the user U stops. For example, as illustrated in the right diagram in FIG. 17, when the user U stops at a red light, the moving object 20 stops accordingly. Therefore, the Earth’s rotation angular velocity calculation unit 232 of the moving object 20 can prevent the accuracy of the ground speed Vgnd from decreasing by reacquiring the Earth’s rotation angular velocity ωer when the moving object 20 comes to rest.

### 7. Hardware Configuration Example

The embodiment of the present disclosure have been described above. Information processing such as the calculation of the Earth’s rotation angular velocity ωer and the calculation of the ground speed Vgnd described above is implemented by a combination of software and hardware of the moving object 20 described below.

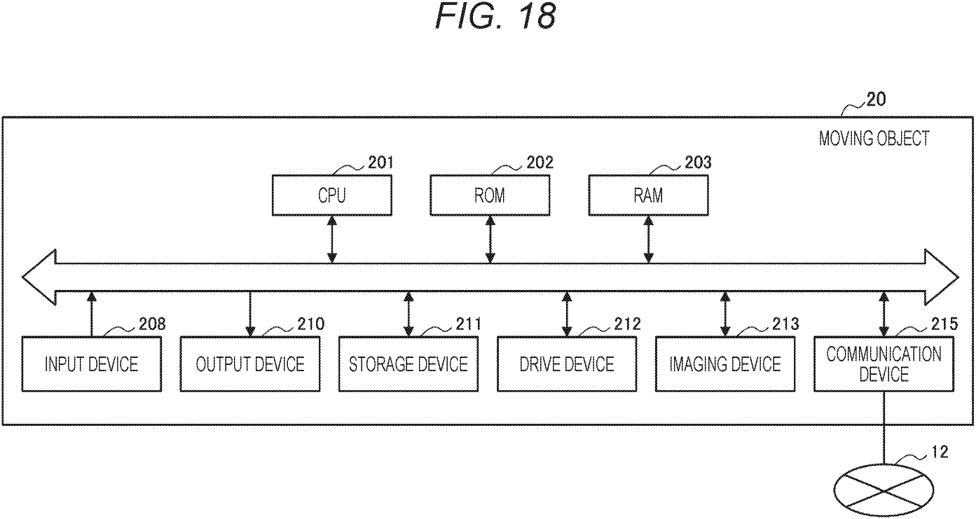

FIG. 18 is an explanatory diagram illustrating a hardware configuration of the moving object 20. As illustrated in FIG. 18, the moving object 20 includes a central processing unit (CPU) 201, a read only memory (ROM) 202, a random access memory (RAM) 203, an input device 208, an output device 210, a storage device 211, a drive device 212, an imaging device 213, and a communication device 215.

The CPU 201 functions as an operation processing device and a control device, and controls the overall operation in the moving object 20 in accordance with various programs. Furthermore, the CPU 201 may be a microprocessor. The ROM 202 stores programs, operation parameters, and the like that are used by the CPU 201. The RAM 203 temporarily stores programs used for execution on the CPU 201, parameters that vary as needed during the execution, and the like. Such components are connected to each other over a host bus including a CPU bus or the like. The above-described functions of the Earth’s rotation angular velocity calculation unit 232, the azimuth determination unit 236, the ground angular velocity calculation unit 240, the radius of gyration calculation unit 244, the ground speed calculation unit 248, the coordinate transformation unit 252, the INS speed calculation unit 256, the position calculation unit 260, the movement control unit 264, and the like can be implemented by a combination of hardware such as the CPU 201, the ROM 202, and the RAM 203 and software.

The input device 208 includes input means for a user to input information, such as a mouse, a keyboard, a touchscreen, a button, a microphone, a switch, and a lever, an input control circuit that generates an input signal on the basis of user input and outputs the input signal to the CPU 201, and the like. The user of the moving object 20 can input various data into the moving object 20 or instruct the moving object 20 to perform a processing operation by operation of the input device 208.

The output device 210 includes, for example, a display device such as a liquid crystal display (LCD) device, an organic light emitting diode (OLED) device, and a lamp. The output device 210 further includes an audio output device such as a speaker and headphones. For example, the display device displays a captured image, a created image, or the like. On the other hand, the audio output device converts voice data or the like into a voice and outputs the voice.

The storage device 211 is a data storage device configured as an example of a storage unit of the moving object 20 according to the present embodiment. The storage device 211 may include a storage medium, a recording device that records data on the storage medium, a reading device that reads data from the storage medium, an easing device that erases data recorded on the storage medium, and the like. The storage device 211 stores programs to be executed by the CPU 201 and various data.

The drive device 212 is a device that generates a driving force. The driving force generated by the drive device 212 is converted into a propulsion force that causes a moving mechanism such as a propeller or a tire to move the moving object 20.

The imaging device 213 includes an imaging optical system such as an imaging lens and a zoom lens that concentrates light, and a signal conversion element such as a charge coupled device (CCD) or a complementary metal oxide semiconductor (CMOS). The imaging optical system concentrates light coming from a subject to form a subject image on the signal conversion unit, and the signal conversion element converts the formed subject image into an electrical image signal.

The communication device 215 is, for example, a communication interface including a communication device or the like for establishing connection to a network 12. Furthermore, the communication device 215 may be a wireless local area network (LAN)-compatible communication device, a long term evolution (LTE)-compatible communication device, or a wired communication device that performs wired communication.

Note that the network 12 is a wired or wireless transmission path of information transmitted from a device connected to the network 12. For example, the network 12 may include a public network such as the Internet, a telephone network, or a satellite communication network, various types of local area networks (LANs) including Ethernet (registered trademark), a wide area network (WAN), or the like. The network 12 may further include a private network such as an Internet protocol-virtual private network (IP-VPN).

### 8. Supplement

Although the preferred embodiment of the present invention has been described in detail with reference to the accompanying drawings, the present invention is not limited to such examples. It is obvious that those having ordinary skill in the art of the present invention can conceive various changes or modifications within the scope of the technical idea described in the claims, and it is to be understood that such changes or modifications also fall within the technical scope of the present invention.

For example, herein, each step in the processing in the moving object 20 need not necessarily be performed in time series in the order described as the flowchart. For example, each step in the processing in the moving object 20 may be performed in an order different from the order described as the flowchart, or may be performed in parallel.

Furthermore, it is also possible to create a computer program for causing hardware such as a CPU, a ROM, and a RAM built in the moving object 20 to perform a function equivalent to each component of the moving object 20 described above. Furthermore, a storage medium storing the computer program is also provided.

Furthermore, the effects described herein are merely illustrative or exemplary, and should not be restrictively interpreted. That is, the technology according to the present disclosure can exhibit other effects that are obvious for those skilled in the art from the description given herein together with or instead of the above-described effects.

Note that the following configurations also fall within the technical scope of the present disclosure.

(1) An information processing device including:
a ground angular velocity calculation unit configured to calculate a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object; and
a ground speed calculation unit configured to calculate a ground speed that is a speed of the moving object relative to the ground on the basis of the ground angular velocity and a radius of gyration relating to movement of the moving object.

The information processing device according to the above (1), further including an Earth’s rotation angular velocity calculation unit configured to calculate the Earth’s rotation angular velocity by updating a reference value of an angular velocity in accordance with a change in attitude of the moving object.

The information processing device according to the above (2), in which the Earth’s rotation angular velocity calculation unit acquires the reference value on the basis of an angular velocity measured when the moving object is at rest.

The information processing device according to the above (2), in which the Earth’s rotation angular velocity calculation unit estimates a bias of the inertial sensor on the basis of angular velocities measured at a plurality of time points at each of which the moving object is different in attitude and a latitude at which the moving object is located, and removes the bias from the measured angular velocity to acquire the reference value.

The information processing device according to the above (4), in which the ground angular velocity calculation unit calculates the ground angular velocity by further subtracting the bias from the measured angular velocity.

The information processing device according to any one of the above (1) to (5), in which the ground angular velocity calculation unit calculates the ground angular velocity by further subtracting a motion component corresponding to a change in vector in a gravity direction caused by movement of the moving object from the measured angular velocity.

The information processing device according to the above (1), further including an Earth’s rotation angular velocity calculation unit configured to calculate the Earth’s rotation angular velocity on the basis of a geomagnetic azimuth measured by a geomagnetic sensor.

The information processing device according to the above (1), further including an Earth’s rotation angular velocity calculation unit configured to calculate the Earth’s rotation angular velocity on the basis of a relation between a direction of acceleration/deceleration of the moving object in a global coordinate system, the direction of acceleration/deceleration in the global coordinate system being estimated from a GNSS signal received by the moving object and a direction of acceleration/deceleration of the moving object in a sensor coordinate system, the direction of acceleration/deceleration in the sensor coordinate system being measured by the inertial sensor.

The information processing device according to any one of the above (1) to (8), further including an azimuth determination unit configured to determine an azimuth of an orientation of the moving object relative to a direction of a vector of the Earth’s rotation angular velocity.

The information processing device according to the above (9), further including a radius of gyration calculation unit configured to calculate the radius of gyration on the basis of the azimuth determined by the azimuth determination unit, a latitude at which the moving object is located, and an Earth’s radius.

The information processing device according to the above (10), in which the radius of gyration calculation unit uses a radius based on the latitude and a longitude at which the moving object is located as the Earth’s radius.

The information processing device according to any one of the above (1) to (11), further including a coordinate transformation unit configured to transform the ground speed into a speed in a global coordinate system by rotating the ground speed so as to make a direction of a vector of the Earth’s rotation angular velocity coincident with an orientation of the moving object in a sensor coordinate system.

The information processing device according to any one of the above (1) to (12), further including a vertical speed calculation unit configured to calculate a vertical speed of the moving object on the basis of acceleration of the moving object measured by the inertial sensor and an estimated altitude direction that is an altitude direction based on estimation.

The information processing device according to the above (13), in which the vertical speed calculation unit corrects the estimated altitude direction using the ground speed as a constraint condition.

An information processing method including:
calculating a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object; and
calculating a ground speed that is a speed of the moving object relative to the ground on the basis of the ground angular velocity and a radius of gyration relating to movement of the moving object.

A program for causing a computer to function as:
a ground angular velocity calculation unit configured to calculate a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object; and
a ground speed calculation unit configured to calculate a ground speed that is a speed of the moving object relative to the ground on the basis of the ground angular velocity and a radius of gyration relating to movement of the moving object.

REFERENCE SIGNS LIST

| | |
|---|---|
| 20 | Moving object |
| 224 | Inertial sensor group |
| 228 | GNSS signal processing unit |
| 232 | Earth’s rotation angular velocity calculation unit |
| 236 | Azimuth determination unit |
| 240 | Ground angular velocity calculation unit |
| 244 | Radius of gyration calculation unit |
| 248 | Ground speed calculation unit |
| 252 | Coordinate transformation unit |
| 256 | INS speed calculation unit |
| 260 | Position calculation unit |
| 264 | Movement control unit |

1. An information processing device comprising:
a ground angular velocity calculation unit configured to calculate a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object; and
a ground speed calculation unit configured to calculate a ground speed that is a speed of the moving object relative to the ground on a basis of the ground angular velocity and a radius of gyration relating to movement of the moving object.

2. The information processing device according to claim 1, further comprising an Earth’s rotation angular velocity calculation unit configured to calculate the Earth’s rotation angular velocity by updating a reference value of an angular velocity in accordance with a change in attitude of the moving object.

3. The information processing device according to claim 2, wherein the Earth’s rotation angular velocity calculation unit acquires the reference value on a basis of an angular velocity measured when the moving object is at rest.

4. The information processing device according to claim 2, wherein the Earth’s rotation angular velocity calculation unit estimates a bias of the inertial sensor on a basis of angular velocities measured at a plurality of time points at each of which the moving object is different in attitude and a latitude at which the moving object is located, and removes the bias from the measured angular velocity to acquire the reference value.

5. The information processing device according to claim 4, wherein the ground angular velocity calculation unit calculates the ground angular velocity by further subtracting the bias from the measured angular velocity.

6. The information processing device according to claim 1, wherein the ground angular velocity calculation unit calculates the ground angular velocity by further subtracting a motion component corresponding to a change in vector in a gravity direction caused by movement of the moving object from the measured angular velocity.

7. The information processing device according to claim 1, further comprising an Earth’s rotation angular velocity calculation unit configured to calculate the Earth’s rotation angular velocity on a basis of a geomagnetic azimuth measured by a geomagnetic sensor.

8. The information processing device according to claim 1, further comprising an Earth’s rotation angular velocity calculation unit configured to calculate the Earth’s rotation angular velocity on a basis of a relation between a direction of acceleration/deceleration of the moving object in a global coordinate system, the direction of acceleration/deceleration in the global coordinate system being estimated from a GNSS signal received by the moving object and a direction of acceleration/deceleration of the moving object in a sensor coordinate system, the direction of acceleration/deceleration in the sensor coordinate system being measured by the inertial sensor.

9. The information processing device according to claim 1, further comprising an azimuth determination unit configured to determine an azimuth of an orientation of the moving object relative to a direction of a vector of the Earth’s rotation angular velocity.

10. The information processing device according to claim 9, further comprising a radius of gyration calculation unit configured to calculate the radius of gyration on a basis of the azimuth determined by the azimuth determination unit, a latitude at which the moving object is located, and an Earth’s radius.

11. The information processing device according to claim 10, wherein the radius of gyration calculation unit uses a radius based on the latitude and a longitude at which the moving object is located as the Earth’s radius.

12. The information processing device according to claim 1, further comprising a coordinate transformation unit configured to transform the ground speed into a speed in a global coordinate system by rotating the ground speed so as to make a direction of a vector of the Earth’s rotation angular velocity coincident with an orientation of the moving object in a sensor coordinate system.

13. The information processing device according to claim 1, further comprising a vertical speed calculation unit configured to calculate a vertical speed of the moving object on a basis of acceleration of the moving object measured by the inertial sensor and an estimated altitude direction that is an altitude direction based on estimation.

14. The information processing device according to claim 13, wherein the vertical speed calculation unit corrects the estimated altitude direction using the ground speed as a constraint condition.

15. An information processing method comprising:
calculating a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object; and
calculating a ground speed that is a speed of the moving object relative to the ground on a basis of the ground angular velocity and a radius of gyration relating to movement of the moving object.

16. A program for causing a computer to function as:
a ground angular velocity calculation unit configured to calculate a ground angular velocity that is an angular velocity of a moving object relative to a ground by subtracting an Earth’s rotation angular velocity that is an angular velocity produced by an Earth’s rotation from a measured angular velocity that is an angular velocity measured by an inertial sensor provided in the moving object; and
a ground speed calculation unit configured to calculate a ground speed that is a speed of the moving object relative to the ground on a basis of the ground angular velocity and a radius of gyration relating to movement of the moving object.
